(19) United States
(12) Patent Application Publication
(10) Pub. No.: US 2011/0081057 A1
(43) Pub. Date: Apr. 7, 2011

(54) APPARATUS FOR STENOSIS ESTIMATION

(75) Inventor: GUANG ZENG, Rochester, MN (US)

(73) Assignee: EIGEN, LLC, GRASS VALLEY, CA (US)

(21) Appl. No.: 12/574,323

(22) Filed: Oct. 6, 2009

(51) Int. Cl. G06K 9/00

(52) U.S. Cl. 382/128

(57) ABSTRACT

Digital Subtraction Angiography (DSA) is widely used in the diagnosis and treatment of coronary arterial diseases such as arterial stenosis. However, the application of DSA for the assessment of stenosis severity is limited by the high intraobserver and interobserver variabilities associated with the visual assessment of stenosis severity from a cineangiogram (e.g., a sequential series of images after injection of a contrast media). The advent of Quantitative coronary angiography (QCA) has significantly reduced this limitation.

### CROSS-REFERENCE TO RELATED APPLICATION

This application claims priority and the benefit of the filing date under 35 U.S.C. 119 to U.S. Provisional Application No. 61/130,080, entitled, “A NEW APPARATUS FOR STENOSIS ESTIMATION,” filed on Oct. 6, 2008, the contents of which are incorporated herein as if set forth in full.

### FIELD OF INVENTION

Digital Subtraction Angiography (DSA) is widely used in the diagnosis and treatment of coronary arterial diseases such as arterial stenosis. However, the application of DSA for the assessment of stenosis severity is limited by the high intraobserver and interobserver variabilities associated with the visual assessment of stenosis severity from a cineangiogram (e.g., a sequential series of images after injection of a contrast media). The advent of Quantitative coronary angiography (QCA) has significantly reduced this limitation.

### BACKGROUND

A stenosis is an abnormal narrowing in a blood vessel or other tubular organ or structure. Several surveillance techniques may be used in the detection of stenosis development such as color Doppler ultrasonography (US) and Digital subtraction angiography (DSA). DSA is a type of Fluoroscopy technique used in interventional radiology to visualize blood vessels in a bony or dense soft tissue environment. A series of images are produced using contrast medium by subtracting a ‘pre-contrast image’ or the mask from later images, once the contrast medium has been introduced into a structure. DSA is commonly used in the diagnosis and treatment of coronary arterial diseases such as arterial stenosis. However, the application of DSA as a standard for the assessment of stenosis severity is limited by the high intraobserver and interobserver variabilities associated with the visual assessment of stenosis severity from the series of images (e.g., cineangiogram). Quantitative analysis of such images such as quantitative coronary angiography (QCA) has been introduced to reduce the quantitative limitations that exist between users. QCA applies standards to a particular stenosis based on a percentage of blockage.

Various background subtraction-based image processing techniques have been proposed to enhance angiographic images. However, all of them suffer from several important limitations. First, they use a “mask” image of the background taken prior to stent deployment. The long delay between acquisition of the mask image and the image with stent present makes involuntary patient motion a major source of degradation. Second, the subtraction of two images containing random noise results in an image with more noise than the original images.

### SUMMARY

Another objective of the presented inventions is to develop a real-time QCA system for automatic stenosis estimation in DSA image without additional hardware. Once the region of interest is selected by a user, subsequent vessel segmentation and stenosis estimation is automated. As this processes the pixel near the vasculature only, this exploratory type method is attractive for real-time processing. To detect vessels with different diameters in the image, the presented inventions are applied to different scales; results from different scales are compared. In order to avoid the measurement bias caused by branches and vessel bifurcation, an improved tracing procedure is implemented to valid centerline segments only. On the other hand, a robust stenosis estimation method may be adopted by selecting the most frequent diameter to approximate the reference diameter.

One objective of the presented inventions is to develop and test a fast and accurate computer vision system for stenosis quantification in 2D QCA images by automatically measuring the diameter variation of a vessel along its centerline.

Once a region of interest in the angiographic frame displaying a vascular segment containing stenosis has been digitized, seed points are extracted, and then line segments are fitted to the seed points. After removing the line segments from background noise, line segments belong to the same vessel are combined. A potential stenosis zone is selected by comparing the similarity of the corresponding boundary edges Of a centerline. A recursive exploratory algorithm is applied to trace the accurate centerline in this potential vessel. Among the diameter values measured along the centerline, the most frequent diameter is selected as the reference diameter for stenosis estimation.

The performance of the presented discriminant analysis algorithm is tested using both phantom and clinical data. The percent stenosis measured from the phantom images are within 4% of the actual value. For clinical data, the measured percent stenosis are compared with a deformable-based algorithm, the average difference of the measured stenosis between the two methods is within 5%.

### BRIEF DESCRIPTION OF THE DRAWINGS

For a more complete understanding of the present invention and further advantages thereof, reference is now made to the following detailed description taken in conjunction with the drawings in which:

FIG. 1 illustrates the process flow of the system.

FIG. 2 illustrates process flow of the image processing method of a prior art system.

FIG. 3 illustrates process flow of a moving layer decomposition subsystem.

FIG. 4 illustrates process flow of the main system of a prior art analysis system.

FIG. 5 illustrates process flow of a signal void subsystem

FIG. 6 illustrates the process flow of seed points selection.

FIGS. 7a and 7b illustrate local maxima detected from two directions in a phantom image.

FIG. 8 illustrates the process flow of linear discrimination.

FIG. 9 illustrates the linear discriminator for discriminating seed points from background noise.

FIGS. 10a-f illustrate seed points detected from two directions at different scales in a sample image.

FIG. 11 illustrates the process flow of centerline fitting

FIG. 12 illustrates the linear discriminator for discriminating centerline segments (o) from mistakenly fitted background noise (x).

FIGS. 13a-d illustrate fitted centerline segments in a phantom image (top) and s sample image from clinical data.

FIG. 14a illustrates the process flow of centerline validation

FIG. 14(b) illustrates the process flow of boundary points matching.

FIG. 15 illustrates the results of centerline segments validation on a phantom image.

FIG. 16 illustrates the results of centerline segments smoothing on a sample image from clinical data.

FIG. 17 illustrates the process flow of centerline combination.

FIG. 18 illustrates a segment C₁ and its attraction region. Segments C₂ and C₃ interact with C₁, while C₃ does not.

FIG. 19 illustrates the results after applying centerline combination on a phantom image (left) and a sample image from clinical data (right).

FIGS. 20a-b illustrates the process flow of centerline tracing using recursive tracing.

FIG. 21 illustrates the results of traced centerline point ((dot) from the original centerline (solid line) on a phantom image (top) and a sample image from clinical data (bottom).

FIG. 22 illustrates the process flow of stenosis detection.

FIGS. 23a-b illustrates the results of determining reference diameter.

FIGS. 24a-b illustrates a centerline method: (a) initial detected edge; (b) after edge refinement.

FIG. 25 illustrates the process flow of edge refinement.

FIG. 26 illustrates an example of image calibration.

FIG. 27 illustrates a discriminant analysis system state sequence diagram.

FIG. 28 illustrates an X-ray image of certified Shelly's carotid anthropomorphic vascular phantom.

FIG. 29a-b illustrates a sample phantom images and test results.

### DETAILED DESCRIPTION

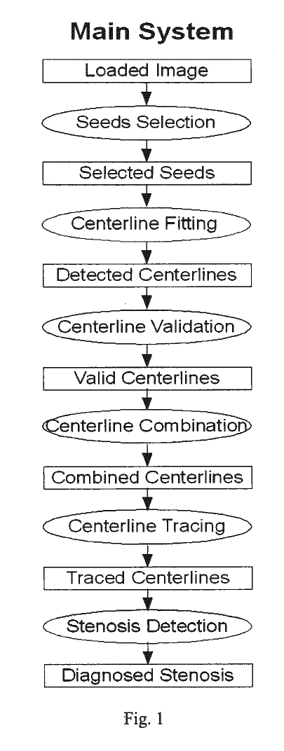

The overall procedures of the algorithm are shown in FIG. 1. After seed points are selected from local maxima in a loaded image, line segments are fitted into the seed points. A validation step based on edge detection is then applied to smooth the line segments caused by vessel bifurcation and vessel curvature. After combining remained centerline segments belong to the same vessel, the standard deviation of the measured width of each line segment is calculated to choose centerline segments whose corresponding vessels with significant width variation. A recursive centerline tracing algorithm is implemented to trace the complete centerline. Finally, a reference diameter is chose along the traced centerline and the percent stenosis of a vessel is measured.

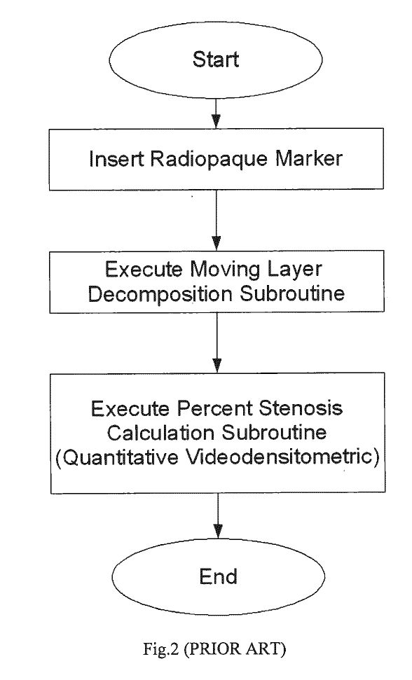

Various background subtraction-based image processing techniques have been proposed to enhance angiographic images. However, all of them suffer from several important limitations. First, they use a “mask” image of the background taken prior to stent deployment. The long delay between acquisition of the mask image and the image with stent present makes involuntary patient motion a major source of degradation. Second, the subtraction of two images containing random noise results in an image with more noise than the original images. To overcome these limitations, attempts to introduce a method of moving layer decomposition have been developed to improve the accuracy of quantitative measurements made from coronary angiograms (QCA). The technique performs tracking and motion-compensated temporal averaging of different image structures (layer) to achieve both background removal and noise reduction. To overcome the problem of tracking errors results from the overlapping vessel and background structures, a radiopaque maker on the delivery balloon, guidewire, or other device are used to provide a trackable feature that is co-moving with the stent vessel. The process flow of the system is shown in FIG. 2.

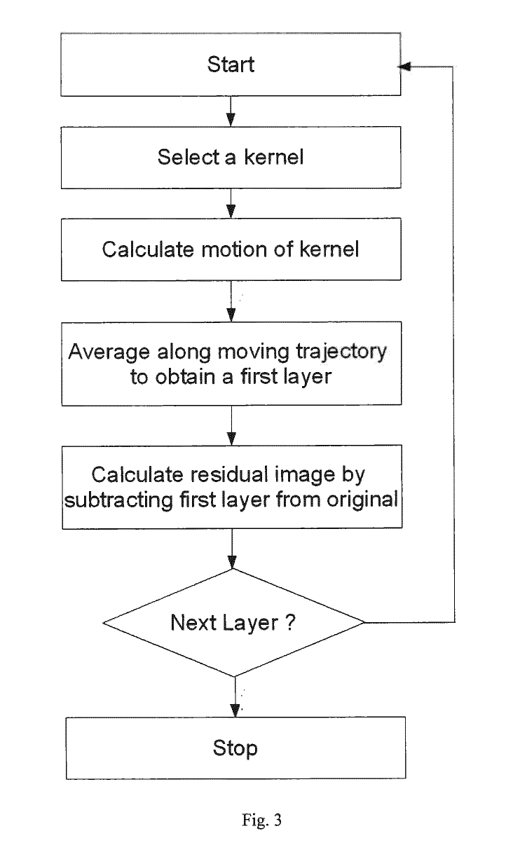

The process flow of the moving layer decomposition is shown in FIG. 3. First, a reference image (or a kernel) is selected, which may be one of the frames, a feature extracted from one of the frames, or a model of a feature known to be present in the frames, such as the marker. Then the optimal motion which best maps the kernel to each frame is calculated. Phase correlation and image blurring are the two preferable techniques for estimating the motion of a layer.

By calculating the phase correlation Φ(kₓ, k_{y}, tᵢ, tⱼ) between two images I(kₓ, k_{y}, tᵢ) and I(kₓ, k_{y}, tⱼ), the yielded delta-function at the true displacement can be used to computing the rotation and scaling.

$$Φ ( {k}_{x} , {k}_{y} , {t}_{i} , {t}_{j} ) = {\sum }_{{k}_{x} {k}_{y}} \frac{I ( {k}_{x} , {k}_{y} , {t}_{i} ) I ( {k}_{x} , {k}_{y} , {t}_{j} )}{{( {\vert I ( {k}_{x} , {k}_{y} , {t}_{i} ) \vert}^{2} {\vert I ( {k}_{x} , {k}_{y} , {t}_{j} ) \vert}^{2} )}^{\frac{1}{2}}} \qquad Eq . ( 1 )$$

Rotation and scaling (r′=r+ar, θ′=θ+φ, where r, θ and φ are coordinates of a polar system) form a pure displacement in the log-polar coordinates because In r′=ln r+ln a, θ′=θ+φ.

Another method for computing translation, rotation and scaling is by using blurred images. The blurred image is obtained by averaging over allowable rotations and scales. Translation is obtained by computing the phase correlation of the resultant blurred images. The actual rotation and scaling is then obtained after compensating for translation. Simply taken the first image as a kernel, a weighted correlation function C_{w} is computed, which is weighted inversely by a Wiener-like filter composed of the estimated image power spectrum P₁ plus an estimate of the noise power P_{N},

$${C}_{w} ( kx , ky , ti , tj ) = \frac{I ( {k}_{x} , {k}_{y} , {t}_{i} ) I ( {k}_{x} , {k}_{y} , {t}_{j} )}{{P}_{1} ( {k}_{x} , {k}_{y} ) + {P}_{N} ( {k}_{x} , {k}_{y} )} \qquad Eq . ( 2 )$$

The maximum of the weighted correlation is taken to be the correct translation (or rotation and scaling when applied to the log-polar images).

Once the motion of a layer is estimated, the layer density is computed using the estimated motion for each point in the kernel. This moving average is an estimate of the first layer. If a feature including the marker is used as the kernel, the stent will be visible in the first layer because of the stent co-moves with the marker. Subsequently, a residual image sequence is computed by subtracting the moving first layer from each image in the time-series images. Then, the previous steps are repeated with a new kernel. The new kernel is selected from the residual image sequence in a similar way as the selection of the first kernel. As each new layer density is computed, previous layer density estimates may be improved by subtracting the density of the new layer, taking into account any relative movement between the two layers.

As a result of the above processing, each layer represents a motion-compensated temporal-average of a certain structure (such as stent) with other layers subtracted away. This image is referred to as “time-average DSA”. By adding the final residual image to the vessel layer, a tracked sequence with background structures subtracted but without temporal averaging is obtained. This is referred to as “tracked DSA sequence”.

These images can be then used to estimate the stenosis on a vessel. A method for quantitatively measuring residual stenosis is adopted. The normal reference segments (proximal and distal) are defined by the operator. Density profiles are then constructed along the segment containing stenosis perpendicular to the centerline. Subsequently, background is subtracted from each density profile using interpolation of the density values from the two edges of the vessel. A normal (theoretic) density profile is constructed at each point along the vessel segment by interpolating of the proximal and distal references size. After determining the actual total density at each point along the vessel segment by integrating the background subtracted density profile, a density deficit index (area stenosis) is defined at each point along the vessel segment by subtracting the actual from the normal total densities, divided by the normal total density. Finally, a global volumetric density deficit index (area stenosis) is determined by subtracting the sum of the actual total density in all points along the vessel segment from the sum of the normal densities, divided by the sum of the normal densities.

Generally, an x-ray angiogram of the blood vessel provides a high degree of accuracy as to the actual extent of stenosis. However, the accuracy of the x-ray angiogram is obtained at great risk during an invasive surgical procedure. As opposed to an x-ray angiogram, magnetic resonance imaging (MRI) is a non-surgical, non-invasive procedure with virtually no risk to the patient and is performed at a cost that is far less then x-ray angiography. However, in determining the precise dimensions of the stenosis, an MRA is problematic. In the general location of the stenosis, there is a signal void which appears as a region with relatively lower image intensity in the gray scale image due to the stenosis in the blood vessel. It is quite difficult to determine the precise percent stenosis due to the signal void contrast to the x-ray angiogram.

Upon further investigation, it has been discovered that the signal void may provide information from which the percent stenosis can be determined given other known factors. It has been found that there is a correlation between turbulence, or random movement, of water molecules in the blood and the nature and extend of the signal void. Consequently, the size and nature of the signal void provides information as to the anatomy or, particularly, the stenosis which created it. Therefore, the signal void can be seen as a signature of the stenosis.

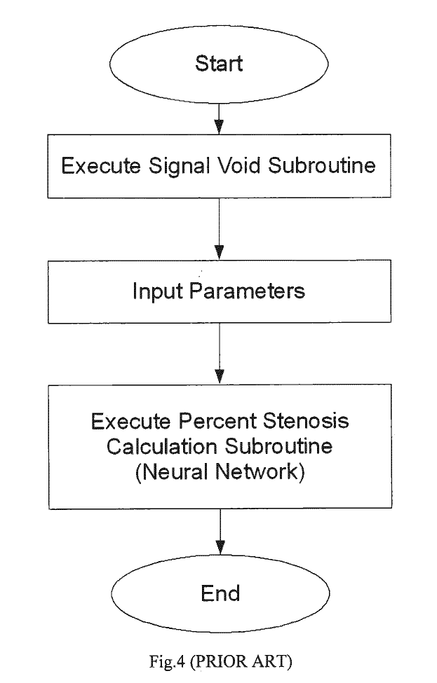

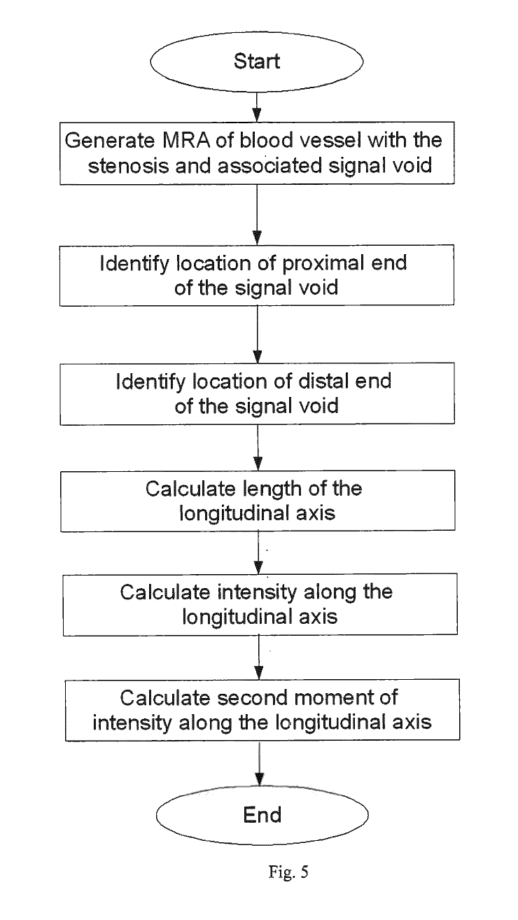

Attempts to use a neural network system for determining a stenosis severity of a blood vessel in magnetic resonance imaging (MRI) data sets have been attempted. The process flow of such a system is shown in FIG. 4. In this system, after a two-dimensional magnetic resonance angiogram (MRA) is generated of a blood vessel using magnetic resonance imaging data from a patient, a signal void subroutine is executed to determine the pertinent anatomic characteristics and image characteristics of the MRA. The process flow of the subsystem is shown in FIG. 5.

The extracted characteristics include the locations of the proximal and distal ends of the signal void which can be identified by manipulation. Thereafter, the length of the longitudinal axis formed between the proximal and distal ends can be calculated. Another signal void characteristic comprising the intensity of the signal void along the longitudinal axis also can be acquired. Meanwhile, an additional signal void characteristic comprising the second moment or standard deviation of the intensity along the longitudinal axis is calculated. The signal void subroutine then examines the MRA for an image characteristic comprising the presence of phase misregistration which refers to the fact that the locations of the protons present in the blood do not stay stationary due to the randomization. The presence of phase misregistration artifact is noted with a logical zero for “no” and a logical one for “yes”.

Some additional parameters such as anatomic or other parameters associated with the particular patient may be input into the signal void subroutine. Such parameters may include, but are not limited to, the blood flow rate, the presence of recirculation flow streak, the curvature of the blood, the diameter of the blood vessel, and the branch angle if there is a relevant bend in the blood vessel.

When the signal void subroutine ends, all the extracted characteristics are sent as the input parameters Iᵢ to the percent stenosis calculation subroutine which employs a neural network to generate one or more output Oₖ. The output Oₖ is preferably the percent stenosis in the blood vessel. However, other outputs may be included such as a certainty value which, for example, may range from 0 to 1 thereby indicating the level of certainty that the percent stenosis is correct.

The neural network includes a hidden layer with a total of four neurons. In calculating an output Oₖ, the inputs Iᵢ are applied to the input nodes which thereafter supply a copy of the inputs Iᵢ to each of the neurons N in the hidden layer. The output of each neuron Nⱼ is a nonlinear function of its inputs. Upon receiving the inputs Iᵢ, the neuron Nⱼ perform a summation Sⱼ of a weighted multiplication of each input Iᵢ defined as

Sⱼ=ΣWᵢⱼIᵢ Eq. (3)

where Wᵢⱼ is defined as the weighting factor associated with each respective input Iᵢ. If the summation Sⱼ reaches a saturation value of the neuron Nⱼ, then the neuron Nⱼ is activated and output a non-zero value. The neural output Hⱼ, is calculated as

Hⱼ=f(Sⱼ) Eq. (4)

using the neuron activation function f(x) which maybe a hyperbolic tangent sigmoid function or a linear ramp function. The output Hⱼ are then applied to an output node Mₖ that performs a summation Uₖ of a weighted multiplication of each neural output Hⱼ defined by

Uₖ=ΣWⱼₖHⱼ Eq. (5)

where Wⱼₖ is the weighting factor associated with each respective neural output Hⱼ. Finally, the output Oₖ is calculated as using the output node activation function f as function of the summation Uₖ, where Oₖ=f(Uₖ).

Before the neural network can be used to generate the output Oₖ form the inputs Iᵢ, the neural network is trained to recognize patterns using supervised training methods. Training is accomplished first by identifying a number of sets of training inputs Iᵢ, each training input sets has a corresponding desired outputs. During training, the neural network is exposed to the training input sets, thereby generating a corresponding output. The corresponding output Oₖ from the output node Mₖ is compared to the desired output from each training input set. A mean squared network error is then calculated between the corresponding and desired output and thereafter, the neural network adjusts its weighting factors W to minimize this error. The application of all of the training inputs sets to be used in a given circumstance is called an epoch. Generally, several epochs occur before the neural network is trained acceptably. This process is repeated with sets of known input(s)/output(s) until the mean-squared error of the outputs is below a prescribed tolerance.

Instead of using additional equipments to indicate stenosis area, more researchers focus on stenosis detection based on information contained in DSA images only. A classical approach to the stenosis detection in images is based on a two step procedure. The first step is to segment vessels in the region of interest, and then the second step is applied to estimate the stenosis by measuring the width variation of the segmented vessels.

Several semi-automatic methods were developed to segment the vessel from user-defined points. One method required manually indicating a number of center positions in the vessel segment after which a contour of the vessel was segment by searching edge points along the line perpendicular to the direction of the centerline points. Another method extracted the centerline from a user-defined seed point by region growing based segmentation and subsequent path extraction.

Recently, some automatic systems were developed for vessel segmentation. They can be categorized as two types. The first type, referred as the pixelwise approach, worked by adaptive filtering, followed by thinning and branch point processing. These methods require the processing of each pixel in the image that makes them unsuitable for real-time applications. The other type, referred as the exploratory algorithm, exemplified by the presented procedures and several others, work by first locating an initial point and then exploiting local image properties to trace the vasculature recursively. These methods process the pixels near the vasculature only, avoiding the processing of every image pixel in the image.

Current Method

Seeds Selection

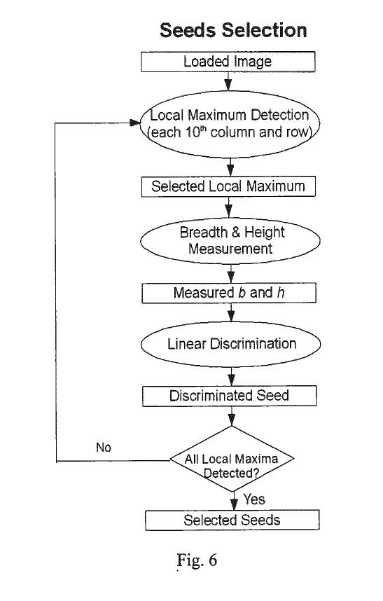

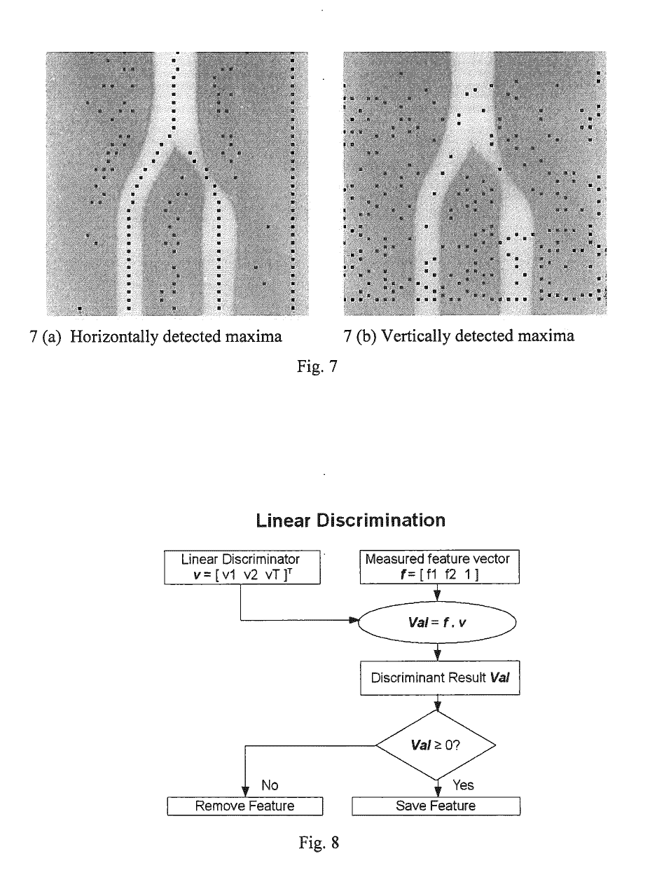

The first step of the algorithm or process of FIG. 1 is to select seed points from the image. The process flow of this step is shown in FIG. 6. Local maxima is searched in the smoothed image, which is obtained by convolving with a low-pass Gaussian filter (σ=2.0) to reduce the effects of noise (See FIG. 7). Computation is greatly reduced by searching in 1-D, only along a fraction 1/Nₒ of the rows and columns of the original image, where Nₒ is the spacing between horizontal or vertical grid lines that are processed.

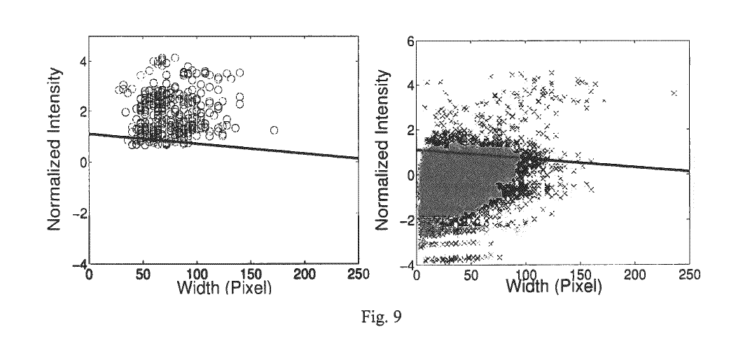

For each candidate seed point, two properties are computed: the height e, which is the normalized gray level intensity value, and the breadth b, which is the image distance between the two neighboring local minima on either side of the maximum. This distance is computed horizontally (vertically) for candidate seed points along the rows (columns). To distinguish true seed points from local maxima due to background noise, a linear discrimator v=[v₁ v₂ v_{T}]^{T} is applied to the (b, e) pair. Points for which [b e 1] v≧0 are retained as seed points, while the other points are discarded. The process flow of this linear discrimination step is shown in FIG. 8, and the discriminator v learned by applying the perceptron algorithm to data collected from a training set is shown in FIG. 9. The positive examples include all the pixels along a centerline, while the negative examples include the remaining pixels. The plot shows the results from all three image sizes, scaled to the original size. The true positive rate, or sensitivity, of the discriminator v on the training set is 92%.

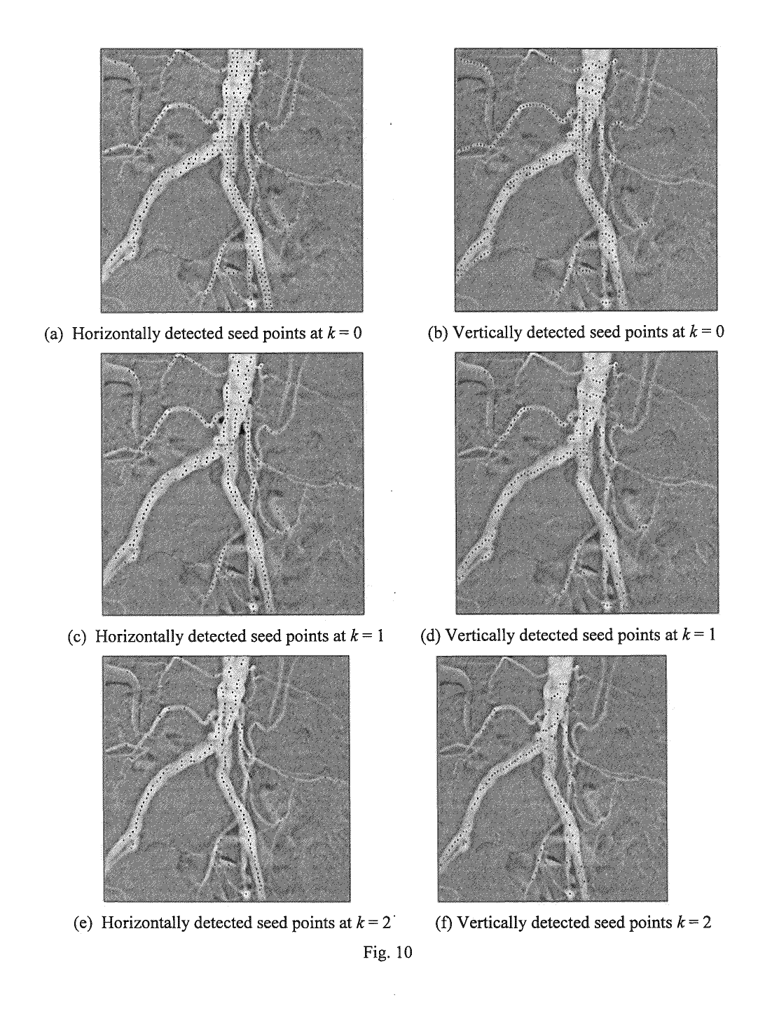

By processing only every tenth row and every tenth column, 90% of the data is ignored outright. After seed points have been detected, then more than 99.6% of the data is ignored in subsequent processing, thus greatly improving the running time of the algorithm. To detect vessel with different diameters, the seed point detection is applied at three separate image scales, downsampling by a factor of two in each direction for each successive scale. For the downsampled image at level k, the grid spacing used is Nₖ=N₀2^{-k}, k=0, 1, 2. The result of this seed point selection step by rows and by columns is displayed in FIG. 10a-f.

Centerline Fitting

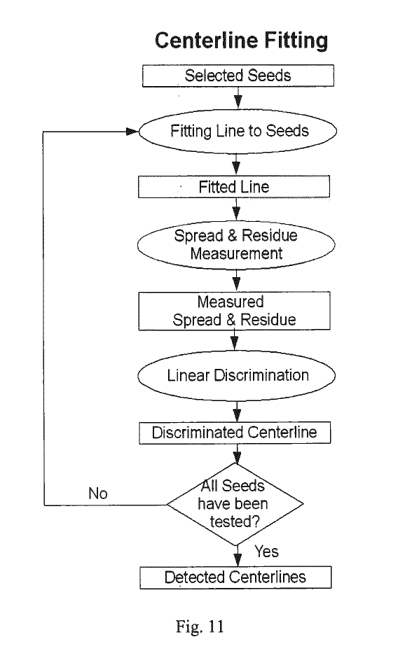

Once seed points have been detected in an image, they are used to estimate the location of the blood vessel centerlines. See FIG. 1. A region-growing procedure is adopted to group the seed points. A point is selected at random, along with its closest neighbor, and a line segment is fit to the pair. The segment is then extended and adjusted by iteratively incorporating nearby seed points. The process of adding line points is continued until no more line points are found in the current neighborhood or until the next candidate has already been added to another line. The process flow of this centerline fitting step is shown in FIG. 11.

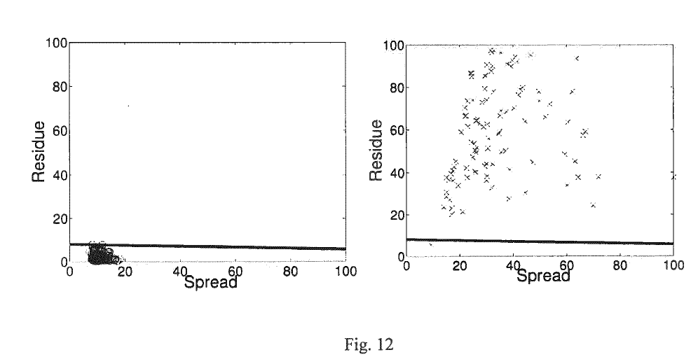

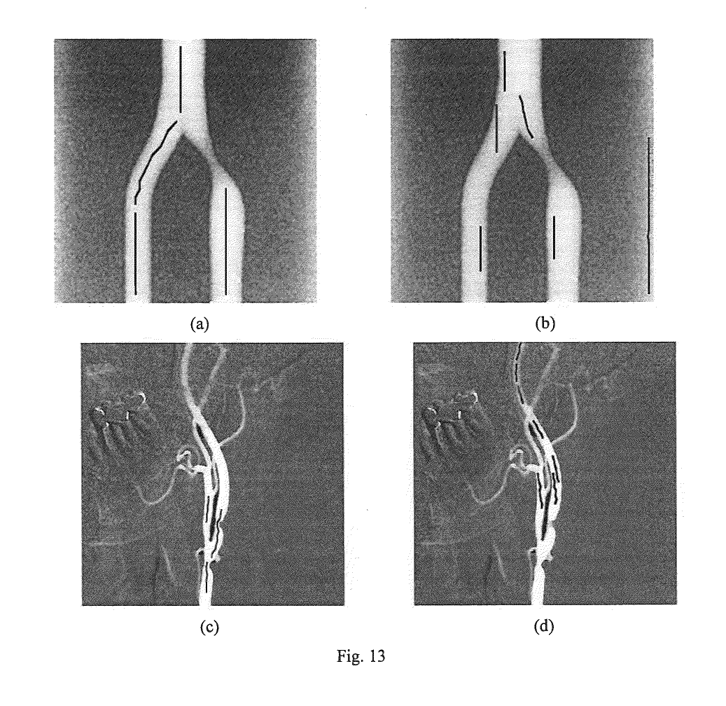

For each fitted centerline segment sᵢ, a pair of geometric features are measured, spread and residue. The spread of a line segment is equivalent to the average distance between neighboring points in the set, with neighbors defined by first ordering the points according to their projection onto the segment. The residue is defined as the mean squared error of the points with respect to their distance from sᵢ. For segments whose spread g₁ and residue g₂ are small, using the discriminant function shown in FIG. 12, the points belonging to the segment are removed from further consideration. An example of centerline fitting is shown in FIG. 13.

Centerline Validation

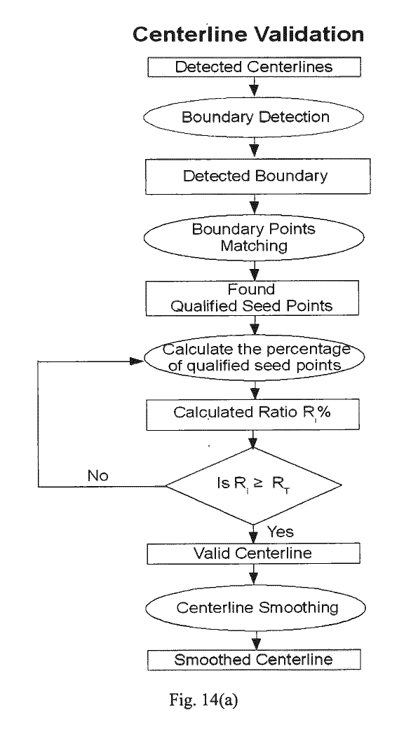

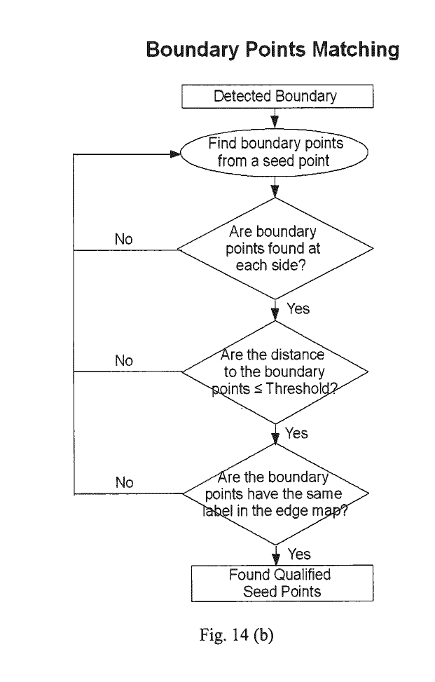

Because this procedure is based solely upon the coherence of the locations of local maxima in the image intensity function, it sometimes detects bright regions in the background in addition to the actual centerline segments (See FIG. 13(b)). Meanwhile, vessel bifurcation may cause false positive errors. As shown in FIG. 13(c), because of the vessel bifurcation, the fitted line segment includes seed points belong to different vessel. On the other hand, since different roots are deleted at three scales, fitted line segment using seed points found at improper scale may cause bias (See FIG. 13(d)). Therefore, a validation method is performed first to remove the false positives, and then an additional step is applied to correct the deviation. The process flow of this centerline validation step is shown in FIG. 14.

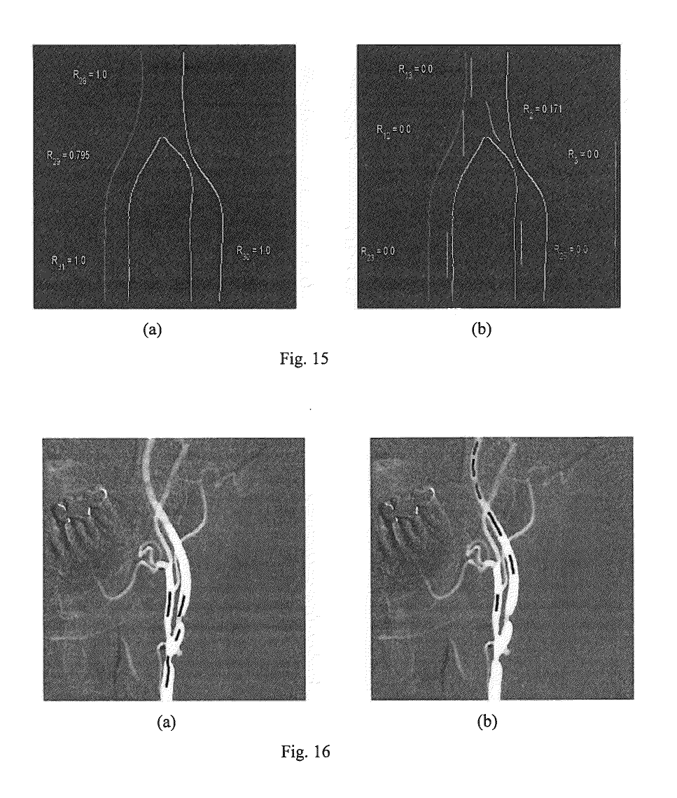

As shown in FIG. 11, firstly applying Canny edge detector to the original gray level image, and then removing the spurs, an edge map of the image is acquired after labeling each remained edge. For each point Cᵢ on a centerline segment C, a search is performed along the line perpendicular to the centerline segment at Cᵢ to find the two nearest points two nearest points Bᵢ^{left} and Bᵢ^{right} that intersect the boundary edge, their corresponding labels Lᵢ^{left} and Lᵢ^{right} in the edge map are also stored. Since each vessel has a pair of continuous boundary at each side, it is assumed that a valid centerline segment C should meet the following requirements:
Each point Cᵢ on C can find a pair of boundary points;
The distance from the point Cᵢ to its boundary points is less than half of the initial width of the C;
The found boundary points at each side in the edge map have the same label.
   Therefore, a centerline C is validated by counting the number of points along the line segment C that meets all the requirements above. The ratio, Rᵢ, between the qualified points and the total number of points on the line is calculated, any line segment C with a ratio value Rᵢ less than a pre-select threshold R_{T} will be removed. The result of centerline validation is shown in FIG. 15.

As shown in FIG. 13(c), because the fitted centerline segments may be close to the bifurcation area or on the branch of the main vessel, for any valid centerline segments, the validation test is applied to its unqualified seed points again. If they met all the requirements mentioned above, they are saved as a new centerline, otherwise they are removed. Meanwhile, in order to solve the problem of scale bias, we smooth the valid centerline segment are smoothed by moving each seed point Cᵢ to the middle point of its corresponding boundary points Bᵢ^{left} and Bᵢ^{right}. The result images are shown in FIG. 16.

The centerline segments with a validation ratio larger than a pre-selected threshold R_{T} (=0.5) remain, the centerline segment with a validation ratio less than R_{T} are removed.

Centerline Combination

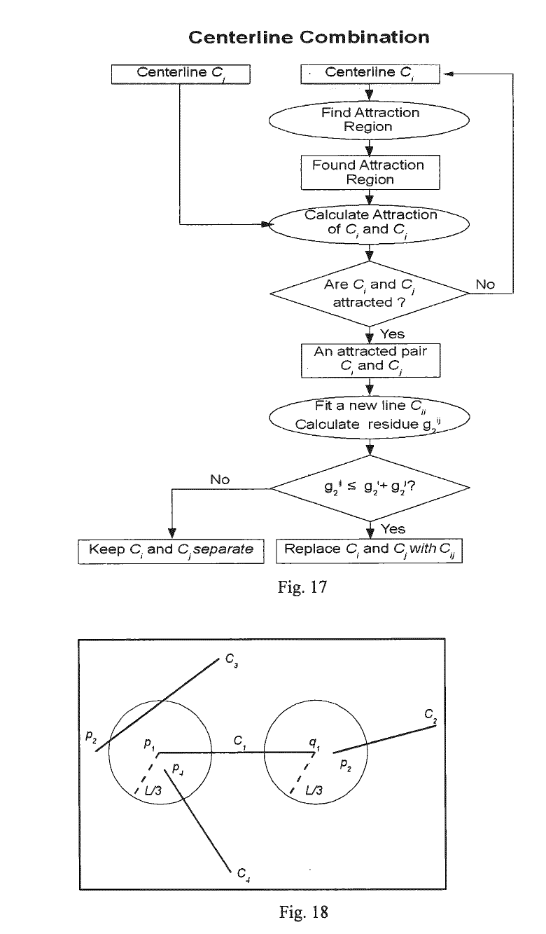

As mentioned above, centerline segments of vessel are detected at different scales. Accordingly, centerline segments of the same vessel at different scale. On the other hand, the centerline fitting procedure may oversegment a vessel. To remedy this problem, a simple method is applied to combine the centerline segments belong to the same vessel. The process flow of this centerline validation step is shown in FIG. 17.

Firstly, a definition of attraction region is selected in accordance with prior processing methods, we define an attraction region Aᵢ of a segment Cᵢ as the set of points such that ωεAᵢ if and only if ∥ωᵢ−pᵢ∥<τᵢ or ∥ωᵢ−qᵢ∥<τᵢ, where pᵢ and qᵢ are the two end points of Cᵢ and τᵢ=l/3. Two segments Cᵢ and Cⱼ are considered to have an attraction interaction with one another if pᵢεAⱼ or qᵢεAⱼ or pⱼεAᵢ or qᵢεAᵢ. Interaction is illustrated in FIG. 18.

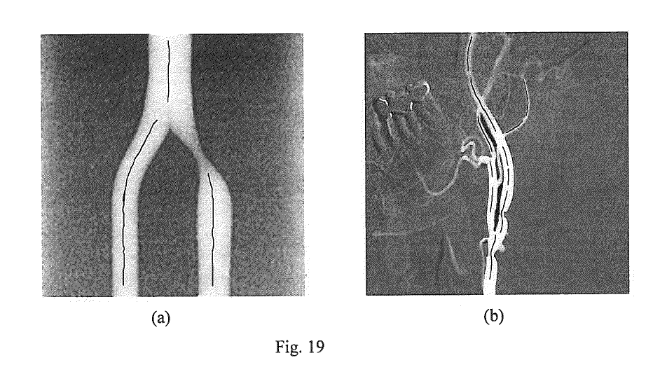

For any two attracted centerline segments Cᵢ and Cⱼ, a new line Cᵢⱼ is fitted using all the seed points on Cᵢ and Cⱼ, and then the residue of the new line g₂^{ij}, is calculate. If g₂^{ij}≦g₂ⁱ+g₂^{j}, Cᵢ and Cⱼ are combined into the single line Cᵢⱼ. The result images are shown in FIG. 19.

Centerline Tracing

Based on the assumption that vessel stenosis can cause significant width variation, the standard deviation of each centerline segment is calculated. Only centerline segments whose standard deviations of width are larger than a pre-selected threshold value will remain for further stenosis analysis.

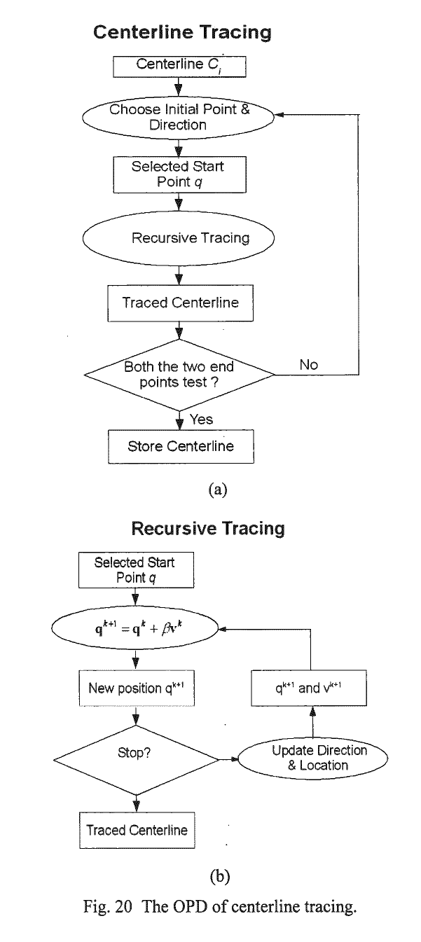

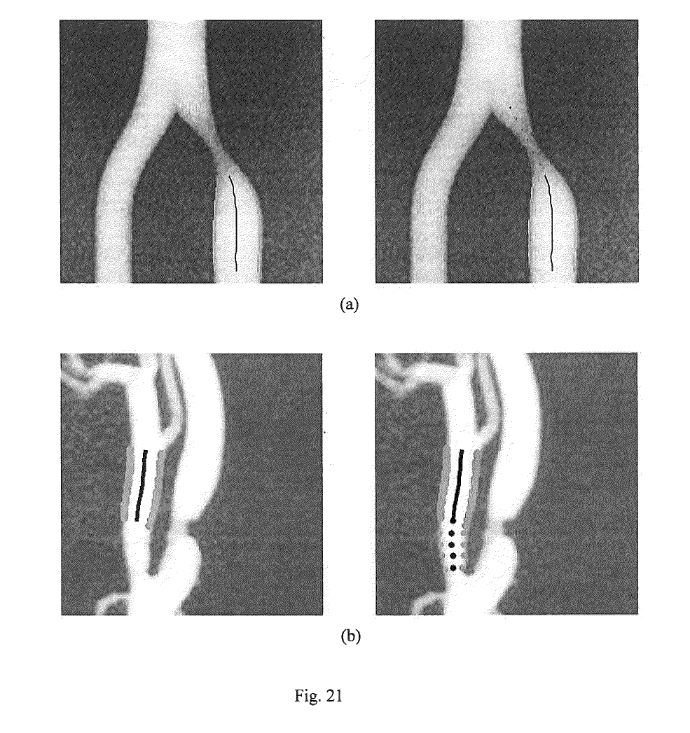

However, as can be seen in FIG. 19, because the low contrast between the vessel and the background in the image, the detected centerlines in the ROI are not complete. To remedy this problem, a modified centerline tracing method is applied. The process flow of this centerline tracing step is shown in FIG. 20.

For each centerline segment, using its endpoint as the initial points q^{k} and the orientation of the line s^{k} as the initial orientation, this method can recursively estimate the next point on the vessel q^{k+1} and its orientation s^{k+1} along the vessel, where k is the iteration number. Denoting v^{k} as a unit vector along the vessel at point q^{k}, it can be expressed as:

$${v}^{k} = [ \begin{matrix}{v}_{x}^{k} \\ {v}_{v}^{k}\end{matrix} ] = [ \begin{matrix}cos ( {s}^{k} ) \\ sin ( {s}^{k} )\end{matrix} ] \qquad Eq . ( 6 )$$

Given the current position q^{k}, we trace the centerline along the current direction s^{k}. The new position vector q^{k+1} can be estimated as:

q^{k+1}=q^{k}+βv^{k} Eq. (7)

where β is a step size.

Because the initial direction s^{k} may not be along the actual direction of the vessel, the location of q^{k+1} is adjusted by searching the precise locations of the estimated boundaries at each side. Using the procedure mentioned above, the corresponding boundary point pair, (C_{left}^{k+1}, C_{right}^{k+1}) of the new point q^{k+1} is found along the direction perpendicular to v^{k}. If distance between q^{k+1} and the mid-point, p^{k+1}, of the found boundary points (C_{left}^{k+1}, C_{right}^{k+1}) is less than a pre-selected threshold d_{T} or there are no boundary points at q^{k+1}, the next position along the current direction v^{k+1}(=v^{k}) is searched, otherwise we replace q^{k+1} with the p^{k+1}, and then update the current direction s^{k+1} using (q^{k}, q^{k+1}). Meanwhile, calculate the width of the vessel w^{k+1} at the new position q^{k+1} is calculated as ∥C_{left}^{k+1}−C_{right}^{k+1}∥.

The tracing procedure is stopped if one or more of the following criteria are satisfied,

(1). The new point q^{k+1} is out of the image boundary;

(2). The extended centerline intersect with another previously detected centerline;

(3). The variation of vessel width converge is below a prescribed tolerance, |w^{k+1}−w^{k}|≦T.

(4). Reach the pre-set iteration number N_{T}.

After apply this recursive procedure at the two end points of a centerline, we can trace the missing part of a centerline caused by low contrast between the vessel and the background, and vessel curvature or bifurcation. The images below display the result of centerline tracing on a low-contrast area (FIG. 21(a)) and a bifurcation area (FIG. 21(b)). are shown below.

Stenosis Detection

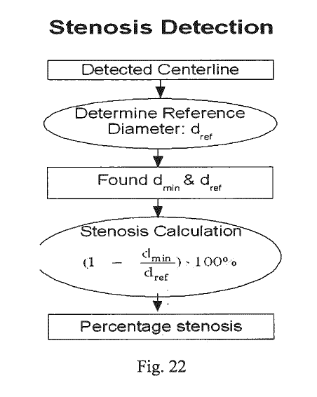

A stenosis is an abnormal narrowing in a blood vessel or other tubular organ or structure. In this paper, the percentage stenosis of a vessel is calculated as:

$$Percent stenosis = ( 1 - \frac{{d}_{min}}{{d}_{ref}} ) \times 100 \% \qquad Eq . ( 8 )$$

where dₘᵢₙ is the minimum diameter along the centerline, and d_{ref} is the stenosis reference diameter. The process flow of this stenosis detection step is shown in FIG. 22.

The pervious step measured the diameter of the vessel at each point along the centerline. Here, the reference diameter d_{ref} is defined as the most frequent diameter. After plotting the diameter profile of the vessel which is the graphical representation of the diameters, d_{ref} is extracted from the diameter profile in the following steps:

(1). Equally divide the diameter values into ten bins;

(2). The histogram is built according to this ten bins and each diameter value is ranged in one bin;

(3). The diameter value corresponding to the highest bin is selected as the most frequent diameter d_{freq}.

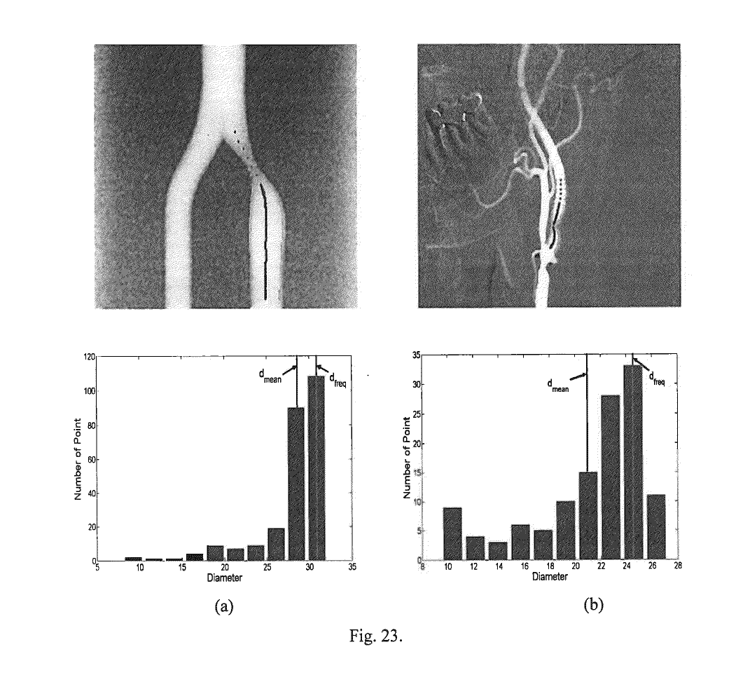

(4). The reference diameter d_{ref} is calculated by taken the mean of d_{freq} and the average diameter dₘₑₐₙ. The results of stenosis detection in some sample images are shown in FIG. 23 and Table. 1.

TABLE 1
The results of stenosis detection

| Image | dₘᵢₙ | d_{ref} | % stenosis |
|---|---|---|---|
| Sample(a) | 8.06 | 29.85 | 73.0 |
| Sample(b) | 9.49 | 23.16 | 59.0 |

Deformable-Based Method for Stenosis Estimation

After detecting the corresponding boundary of a centerline segments, there is an alternative step that can be applied to search the accurate boundary of the vessel using deformable-based techniques such as active contour before estimating the stenosis.

Once the initial edges were obtained from the centerline points, an active contour model can be built to smooth the boundary curve. The active contour model algorithm deforms a contour to lock onto features of interest within in an image. Usually the features are lines, edges, and/or object boundaries. Given an approximation of the boundary of an object in an image, an active contour model can be used to estimate the boundary as lose as possible to actual boundary.

An active contour is an ordered collection of n points Vin the image plane:

V={v₁, v₂ . . . vₙ}

vᵢ=(xᵢ, yᵢ), i=1, . . . n Eq. (9)

The points in the contour iteratively approach the boundary of an object through the solution of an energy minimization problem. For each point in the neighborhood of vᵢ, an energy term is computed:

Eᵢ=αEᵢₙₜ(vᵢ)+βEₑₓₜ(vᵢ) Eq. (10)

where Eᵢₙₜ(vᵢ) is an energy function dependent on the shape of the contour and Eₑₓₜ(vᵢ) is an energy function dependent on the image properties, such as the gradient, near point vᵢ. The constants α and β provide the relative weighting of the energy terms.

The internal energy function is intended to enforce a shape on the deformable contour and to maintain a constant distance between the points in the contour. Additional terms can be added to influence the motion of the contour. The internal energy function used herein is defined as follows:

αEᵢₙₜ(vᵢ)=bE_{con}(vᵢ)+cE_{cur}(vᵢ) Eq. (11)

where, E_{con}(vᵢ) is the continuity energy that enforces the shape of the contour and E_{cur}(vᵢ) is a curvature energy that causes the contour to grow or shrink. c and b provide the relative weighting of the energy terms.

The external energy function attracts the deformable contour to interesting features, such as object boundaries, in an image. Here image gradient is used. The image gradient should be large at the object boundary (β<0). Therefore, the following external energy function is investigated:

β=Eₑₓₜ(vᵢ)=βE_{grad}(vᵢ) Eq. (12)

In summary, the following energy function is minimized at each vᵢ:

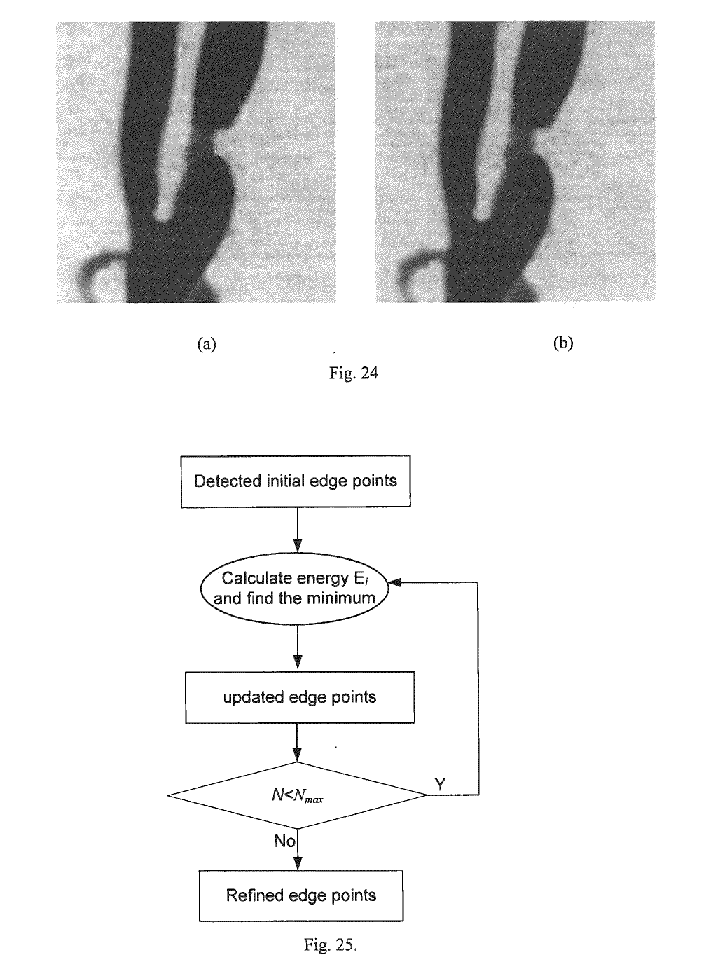

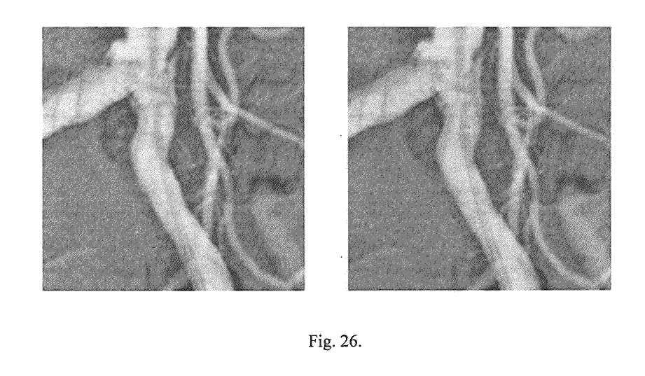

Eᵢ=bE_{con}(vᵢ)+cE_{cur}(vᵢ)+βE_{grad}(vᵢ) Eq. (13)

where b>0, c>0 and β<0. FIG. 24 (b) shows the result after edge refinement in which the initial boundary has been obtained from centerline. FIG. 25 shows the process flow of edge refinement.

Comparison with Deformable-Based Method

The presented method is compared with the deformable-based method. In the eight test images, the same ROI regions are selected, and then the two algorithms are applied. The results are shown below in Table.2.

TABLE 2
The measured stenosis on eight test images using deformable-
based method and the discriminant analysis method.

| | % stenosis | % stenosis | |
|---|---|---|---|
| | Deformable-based | The presented | % |
| Image | method | method | Difference |
| Image. 1 | 11.93 | 12.7 | −0.77 |
| Image. 2 | 57.47 | 57.9 | −0.43 |
| Image. 3 | 8.26 | 12.3 | −4.04 |
| Image. 4 | 24.81 | 19.7 | 5.11 |
| Image. 5 | 48.14 | 63.5 | −15.36 |
| Image. 6 | 19.17 | 21.7 | −2.53 |
| Image. 7 | 15.0 | 24.6 | −9.6 |
| Image. 8 | 9.71 | 10.8 | −1.09 |

As we can see in Table.2, the average absolute difference of the measured stenosis between the two methods is 5.0%. The result of Image.5 gives the largest difference (15.36%), which is caused by the reference diameter d_{ref} chosen.

Calibration

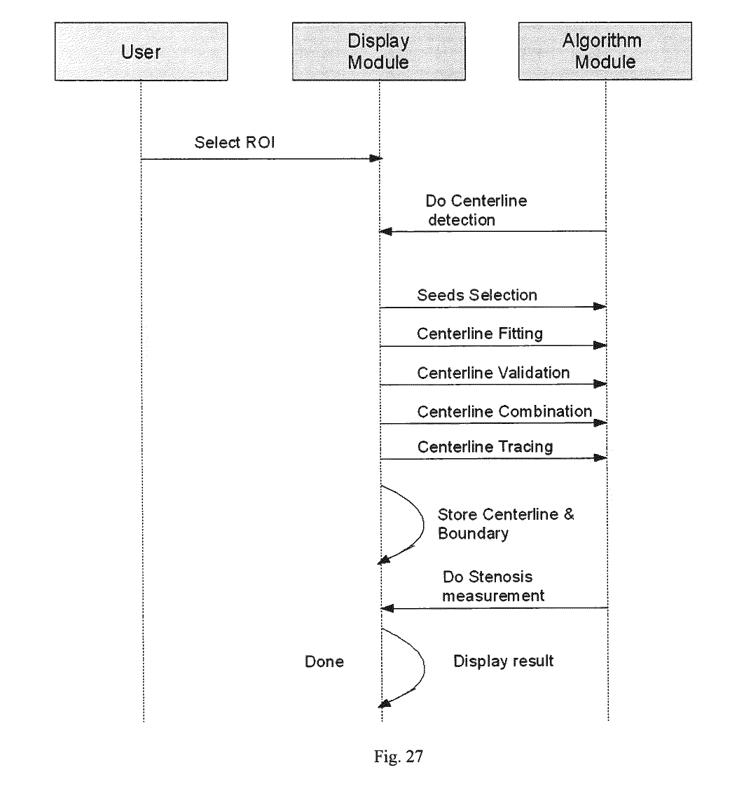

In some specific cases, the actual lesion length and diameter in the final results need to be measured. Therefore, a simple calibration method is applied. To do calibration, the tested image must contain catheter. Because the actual size of the catheter, w, is fixed, we can calibrate the image by measuring the width of the catheter, W, after manually selecting two points on the two sides of the catheter (See FIG. 27). Once the length or diameter value, L, in final results is acquired, its actual value l is calculated as:

$$l = \frac{w}{W} \times L \qquad Eq . ( 14 )$$

Software Architecture

This section describes the image processing architecture of the presented system. In this

discriminant analysis system, once user select the region of interest containing a vascular segment from the loaded image frame, the system will automatically do the stenosis measurement. The state sequence diagram of the system is described in FIG. 27.

### Experimental Results:

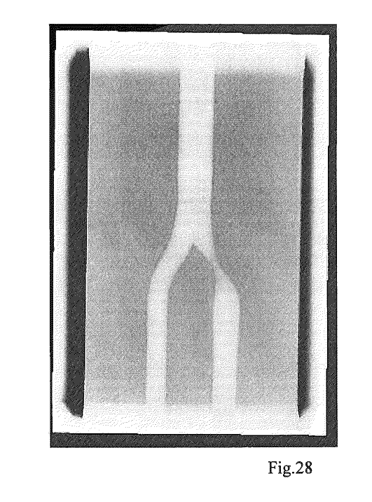

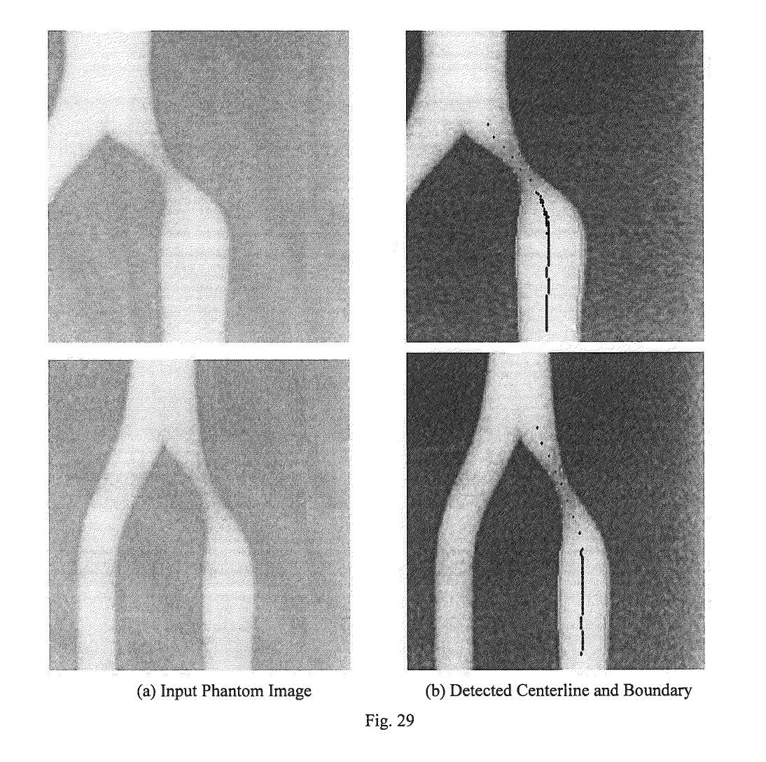

The algorithm was tested on various phantoms having a region of interest with a stenosis. The output images and measured percentage stenosis are shown in FIG. 28 and Table. 3. Compared with ground truth (70%), the calculated average percentage stenosis is 73.9%, the mean error and standard deviation are 3.96% and 0.83% respectively.

TABLE 3
Stenosis measurement results analysis over 10 tests

| Test | % Stenosis |
|---|---|
| 1 | 73.0 |
| 2 | 74.8 |
| 3 | 73.4 |
| 4 | 73.3 |
| 5 | 73.8 |
| 6 | 74.3 |
| 7 | 75.3 |
| 8 | 73.8 |
| 9 | 73.0 |
| 10 | 74.9 |

The presented system is a real-time QCA system for automatic stenosis estimation in DSA image without additional hardware. Once the region of interesting is selected by user, the following vessel segmentation and stenosis estimation is fully automatic. By processing the pixel near the vasculature only, the exploratory type centerline detection method is attractive for real-time processing. To detect vessels with different diameters in the image, our work is applied to different scales. In order to avoid the measurement bias caused by branches and vessel bifurcation, an improved tracing procedure is implemented. A robust method is introduced to estimate stenosis by selecting the most frequent diameter as the reference diameter.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A system for use in the quantitative measurement of the stenosis severity of a blood vessel is presented, the system includes:
a. a seed point selection sub-system for selecting seed points from local maxima in intensity image by a linear discriminate technique;
b. a centerline fitting sub-system for detecting of the centerline segments of a blood vessel by a region growing technique and a linear discriminate technique;
c. a centerline validation sub-system for validating of the detected centerline segments by a boundary matching technique;
d. a centerline combination sub-system for combining the centerline segments of the same blood vessel;
e. a centerline tracing subsystem or detecting of the complete centerline of a blood vessel by a recursive tracing technique;
f. a stenosis detection sub-system for quantitatively measuring percentage stenosis.
